(19) United States
(12) Patent Application Publication
(10) Pub. No.: US 2007/0050706 A1
(43) Pub. Date: Mar. 1, 2007

(54) METHOD OF XML TRANSFORMATION AND PRESENTATION UTILIZING AN APPLICATION-SPECIFIC PARSER

(76) Inventors: Erxiang Liu, Austin, TX (US); Ningning Wang, Round Rock, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/277,968

(22) Filed: Mar. 30, 2006

Related U.S. Application Data
(63) Continuation-in-part of application No. 11/214,566, filed on Aug. 30, 2005.

(51) Int. Cl. G06F 17/00

(52) U.S. Cl. 715/513; 715/523

(57) ABSTRACT

A method of XML transformation and presentation utilizing an application-specific parser is provided. In an exemplary embodiment, the method includes receiving an application-specific XML schema definition and an XML stylesheet. An application-specific parser generation engine is generated by applying the XML schema definition and the XML stylesheet. The application-specific generation engine then generates an application specific transformation parser. The method may also include receiving of an XML document by the application-specific transformation parser. The XML document is transformed in accordance to the application-specific XML schema definition.

### CROSS-REFERENCE TO RELATED APPLICATIONS

The present application is a continuation-in-part under 35 U.S.C. § 120 of U.S. application Ser. No. 11/214,566, entitled “XML COMPILER THAT WILL GENERATE AN APPLICATION SPECIFIC XML PARSER,” filed on Aug. 30, 2005. The present application is related to the following co-pending U.S. patent applications: U.S. patent application filed entitled “ENABLEMENT OF MULTIPLE SCHEMA MANAGEMNT AND VERSIONING FOR APPLICATION-SPECIFIC XML PARSERS,” Docket No. AUS920050754US1; United States Patent Application entitled “GENERATION OF APPLICATION-SPECIFIC XML PARSERS USING JAR FILES WITH PACKAGE PATHS THAT MATCH THE XML XPATHS,” Docket No. AUS920050756US1; and U.S. patent application entitled “METHOD OF XML ELEMENT LEVEL COMPARISON AND ASSERTION UTILIZING AN APPLICATION-SPECIFIC PARSER,” Docket No. AUS920050757US1. All of the aforementioned applications are hereby incorporated by reference in their entireties.

### FIELD OF INVENTION

The present invention generally relates to the field of software, and more particularly to use of an application-specific XML parser for transforming or presenting an XML document.

### BACKGROUND OF THE INVENTION

Extensible Markup Language (XML) is a widely accepted standard for describing data. XML is a standard that allows an author/programmer and the like to describe and define data (e.g., type and structure) as part of the XML content/document. Since XML content may describe data, any application that understands XML regardless of the applications programming language and platform has the ability to process the XML based content.

An XML parser is a software program that reads XML files and makes the information from those files available to applications and programming languages, usually through a known interface. The XML content may optionally reference another document or set of rules that define the structure of an XML document/content. This other document or set of rules is often referred to as a schema. When an XML document references a schema, some parsers may check for validity in which the parser determines if the document follows the rules schema.

The Extensible Markup Language (XML) has become the industry standard for exchanging data across systems because of the language's flexibility and consistent syntax. However, conventional XML parsing (e.g., parsing by use of a general-purpose external parser) is slow in many applications. General-purpose parsers process XML content into general-purpose data structures, then apply run-time analysis to rebind the data to application-specific structures. Extra space is consumed by intermediate data structures (e.g., general purpose data structures) and extra time may be spent creating and analyzing them. Moreover, it is labor intensive to write the conversion code that converts the general-purpose data structures to application-specific data structures required for final processing.

In order to transform one XML document into another, a language known as eXtensible Stylesheet Language: Transformations (XSLT) is often employed. Current XSLT implementations rely on a generic (Document Object Model—DOM) parser to convert the XML document to a tree structure that may be manipulated by applications before it may be transformed into a desired format. Such process is slow and resource consuming. While developers may write an application-specific transformation engine by hand, such process is very labor-intensive.

Therefore, it would be desirable to provide an application-specific transform engine for XML transformation and presentation which overcomes the aforementioned limitations of currently employed technology.

### SUMMARY OF THE INVENTION

In a first aspect of the invention, a method of XML transformation and presentation utilizing an application-specific parser is provided. In the present aspect, the method includes receiving an application-specific XML schema definition and an XML stylesheet. An application-specific parser generation engine then generates an application-specific transformation parser by applying the XML schema definition and the XML stylesheet. The method may also include receiving of an XML document by the application-specific transformation parser. The XML document is transformed in accordance to the application-specific XML schema definition.

In a further aspect of the present invention, a computer program product including a computer useable medium with computer usable program code for creating a method for XML transformation is provided. In an exemplary aspect, the computer program product includes computer usable program code for receiving an application-specific XML schema definition and an XML stylesheet. Computer usable program code for generating an application-specific transformation parser by an application-specific transformation parser engine employing the XML schema definition and the XML stylesheet may also be present. In addition, the method may also include computer usable program code for receiving of an XML document by the application-specific transformation parser and computer usable program code for transforming the XML document in accordance to the application-specific XML schema definition.

In an additional aspect of the present invention, an additional method of XML transformation and presentation utilizing an application-specific parser is disclosed. In such aspect, the method of XML transformation may include accessing an XML schema and XML stylesheet with a computer. For instance, the XML schema includes an XML schema definition. The method may also include generating an application-specific transformation parser in response to accessing the XML schema definition and XML stylesheet by the computer automatically. In addition, the method may include transforming an XML document with the application-specific transformation parser in conformance with the application-specific XML schema definition.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method of XML transformation and presentation utilizing an application-specific parser in accordance with an exemplary embodiment of the present invention;

FIG. 2 is a block diagram illustrating a system for XML transformation and presentation in accordance with an exemplary embodiment of the present invention; and

FIG. 3 is a flow diagram illustrating an additional method of XML transformation and presentation utilizing an application-specific parser in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

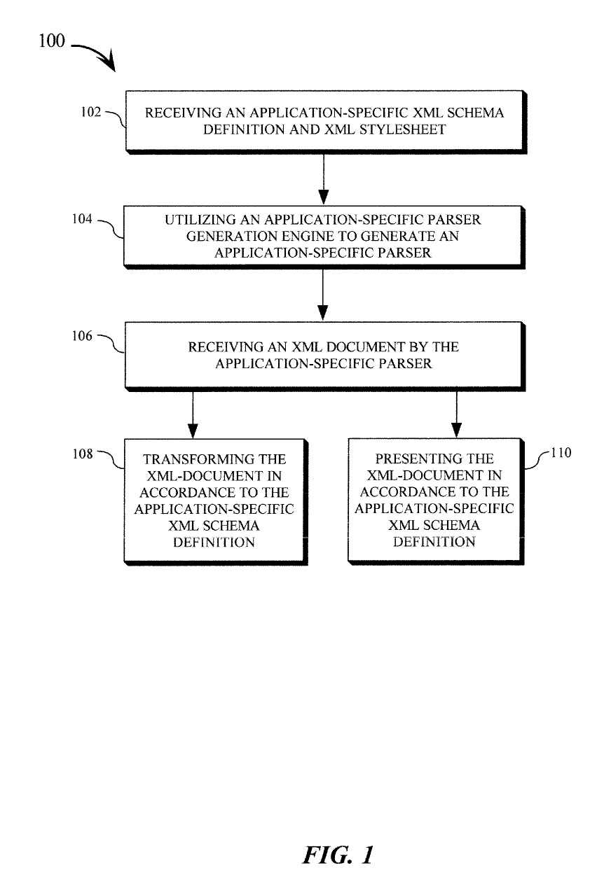

Referring to FIG. 1, a method 100 for XML transformation and presentation utilizing an application-specific parser is provided. In an exemplary embodiment, the method 100 includes receiving an application-specific XML schema definition and an XML stylesheet 102. In an embodiment, the XML schema definition is a XML instances schema definition and the XML stylesheet is a function specific set of semantic actions. A semantic action is an operation that is performed based on a pattern match. In other words, when a pattern is matched or criteria is satisfied a piece of software/code is executed. For example, in the context of a parser, a semantic action is a software routine (e.g., computer instructions) that is executed when a grammar rule has been identified by a parser.

The method 100 may also include utilizing an application-specific parser generation engine to generate an application-specific parser 104 by applying the XML schema definition and the XML stylesheet. For example, the application-specific generation engine generates the application-specific transformation or presentation parser by compiler technology. The application-specific parser may be specific for transformation of an XML document or presentation of an XML document. The method 100 may also include receiving of an XML document by the application-specific transformation parser 108. The XML document may be transformed in accordance to the application-specific XML schema definition 110 or presented in accordance to the application-specific XML schema definition 112. For example, the application-specific transformation parser transforms an XML document by parsing only XML data which conforms to the application-specific XML schema definition.

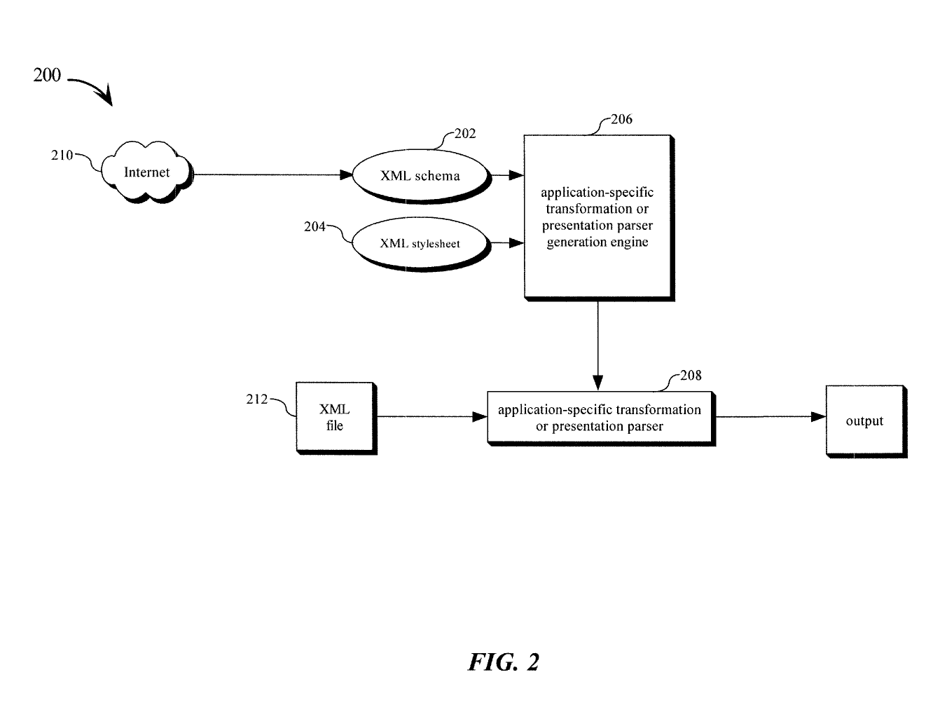

Referring to FIG. 2, a block diagram illustrating a system 200 for XML transformation and presentation in accordance with an exemplary embodiment of the present invention is provided. In an exemplary embodiment, an XML schema 202 and an XML stylesheet 204 are provided to an application-specific parser generation engine 206 to generate an application-specific parser 208. For example, the XML schema is a XML instances schema definition and the XML stylesheet is a function specific set of semantic actions.

With continued reference to FIG. 2, the application-specific parser generation engine 206 may be employed to generate an application-specific parser for transformation of an XML document/file 212 or an application-specific parser for presentation of the XML document/file 212. As illustrated in FIG. 2, in an embodiment, the XML schema 202 may be provided to the application-specific parser generation engine 206 via an external source such as the Internet 210. It is contemplated that additional sources such as a schema repository may provide XML schemas to the application-specific parser generation engine.

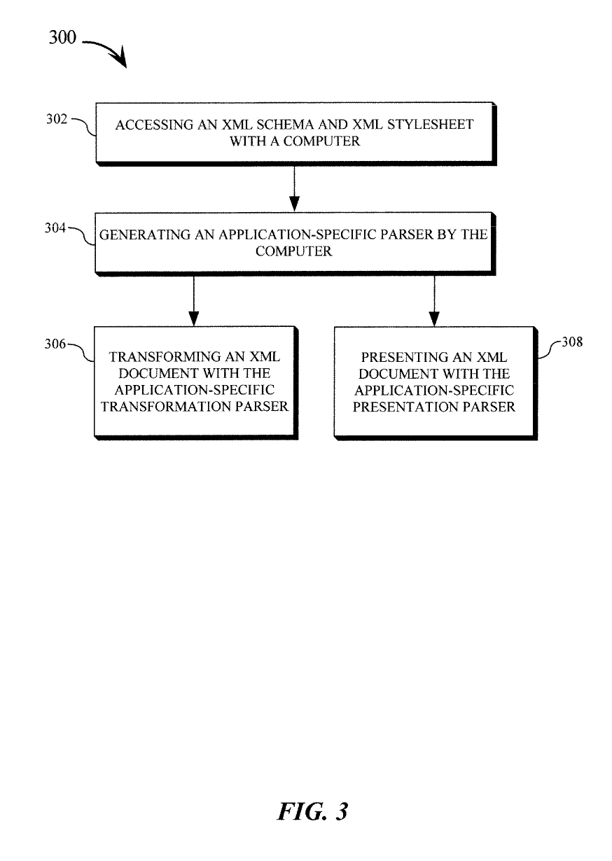

Referring to FIG. 3, an additional method 300 of XML transformation and presentation utilizing an application-specific parser is disclosed. In an exemplary embodiment, the method 300 of XML transformation may include accessing an XML schema and XML stylesheet with a computer 302. The XML stylesheet may be a function specific set of semantic actions.

The method 300 may also include generating an application-specific parser in response to accessing the XML schema definition and XML stylesheet by the computer 304 automatically. For example, the application-specific parser is generated by a use of a compiler. It is contemplated that an application-specific transformation parser or an application-specific presentation parser may be generated. In further embodiments, the method 300 includes generating an application-specific parser generation engine prior to generating an application-specific transformation parser or an application-specific presentation parser.

In addition, the method 300 may include transforming an XML document by the application-specific transformation parser 306 in conformance with the application-specific XML schema definition. For example, the application-specific transformation parser transforms an XML document by parsing only XML data which conforms to the application-specific XML schema definition. Moreover, the method 300 may also include presenting an XML document by the application-specific presentation parser 308 in conformance with the application-specific XML schema definition.

It is to be understood that the disclosed invention may be employed in a number of systems including embedded systems such as a Service Management Framework (SMF). Further, the present invention may be utilized by consulting services such as WebSphere Commerce (WCS) and WebSphere Business Integration (WBI). In addition, the invention may be used in performance critical applications such as SMF and web services. Moreover, the instant invention may be incorporated as a plug-in into an Integrated Development Environment (IDE) such as WebSphere Studio Application Developer (WSAD), Eclipse, and the like.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to become couple to other data processing systems or storage devices through intervening private or public networks. Modems, cable modem and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages is to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of Extensible Markup Language (XML) transformation by use of an application-specific transformation parser, comprising steps of:
receiving an application-specific XML schema definition and an XML stylesheet;
utilizing an application-specific parser generation engine to generate an application-specific transformation parser by applying the XML schema definition and the XML stylesheet;
receiving an XML document by the application-specific transformation parser; and
transforming the XML document in accordance with the application-specific XML schema definition.

2. The method as claimed in claim 1, wherein the step of utilizing an application-specific parser engine to generate an application-specific transformation parser is performed by a compiler.

3. The method as claimed in claim 1, further comprising a step of employing the application-specific parser generation engine to generate an application-specific presentation parser.

4. The method as claimed in claim 1, wherein the XML stylesheet is a function specific set of semantic actions.

5. The method as claimed in claim 1, wherein the XML schema definition is a XML instances schema definition.

6. The method as claimed in claim 1, wherein the application-specific transformation parser transforms an XML document by parsing only XML data which conforms to the application-specific XML schema definition.

7. The method as claimed in claim 1, wherein the XML schema is provided by the Internet.

8. A computer program product, comprising:
a computer useable medium including computer usable program code for creating a method for Extensible Markup Language (XML) transformation, the computer program product including:
computer usable program code for receiving an application-specific XML schema definition and an XML stylesheet;
computer usable program code for utilizing an application-specific parser generation engine to generate an application-specific transformation parser;
computer usable program code for receiving an XML document by the application-specific transformation parser; and
computer usable program code for transforming the XML document in accordance with the application-specific XML schema definition.

9. The computer program product as claimed in claim 8, wherein computer usable program code generates the application-specific transformation parser by accessing a compiler.

10. The computer program product as claimed in claim 8, wherein the computer program product further comprises computer usable program code for generating an application-specific presentation parser.

11. The computer program product as claimed in claim 10, wherein the computer program product further comprises computer usable program code for employing the application-specific presentation parser for presentation of the XML document.

12. The computer program product as claimed in claim 8, wherein the XML schema definition is a XML instances schema definition.

13. The computer program product as claimed in claim 8, wherein the application-specific transformation parser transforms an XML document by parsing only XML data which conforms to the application-specific XML schema definition.

14. A method of transforming an Extensible Markup Language (XML) document, comprising steps of:
accessing an XML schema and XML stylesheet with a computer, the XML schema including an XML schema definition;
generating an application-specific transformation parser in response to accessing the XML schema definition and XML stylesheet, the application-specific transformation parser being generated automatically by the computer; and
transforming an XML document with the application-specific transformation parser, the transforming of the XML document conforming to the application-specific XML schema definition.

15. The method as claimed in claim 14, wherein the step of generating an application application-specific transformation parser is performed by a compiler.

16. The method as claimed in claim 14, further comprising the step of generating an application-specific presentation parser for presentation of the XML document.

17. The method as claimed in claim 14, wherein the XML stylesheet is a function specific set of semantic actions.

18. The method as claimed in claim 14, wherein the XML schema definition is a XML instances schema definition.

19. The method as claimed in claim 14, wherein the application-specific transformation parser transforms an XML document by parsing only XML data which conforms to the application-specific XML schema definition.

20. The method as claimed in claim 14, further comprising the step of generating an application-specific parser generation engine prior to generating an application-specific transformation parser.
